(19) United States
(12) Patent Application Publication
(10) Pub. No.: US 2005/0281977 A1
(43) Pub. Date: Dec. 22, 2005

(54) Method of carpet construction

(76) Inventor: Larry E. Mashburn, Rockyface, GA (US)

Correspondence Address: MILES & STOCKBRIDGE PC, 1751 PINNACLE DRIVE, SUITE 500, MCLEAN, VA, 22102-3833, US

(21) Appl. No.: 11/044,639

(22) Filed: Jan. 24, 2005

Related U.S. Application Data
(60) Provisional application No. 60/538,233, filed on Jan. 23, 2004.

(51) Int. Cl. B32B 33/00; B32B 31/00

(52) U.S. Cl. 428/95; 428/97; 156/324; 156/325; 156/72

(57) ABSTRACT

A continuous method of adhesively laminating a first textile substrate to a second textile substrate wherein a single laminating adhesive is applied in one step, the method comprising, moving a web of the first textile along a first substantially horizontal path, coating the upper surface of the moving web of first textile with a substantially uniform layer of adhesive capable of bonding a surface of the first textile to a surface of the second textile, moving a web of the second textile along a second substantially horizontal path that is vertically spaced above the coated surface of, substantially parallel to, substantially coextensive with and moving at substantially the same speed as the moving web of first textile, bringing the coated surface of the moving web of first textile into contact with the lower surface of the moving web of second textile under conditions and for a time sufficient to adhere the contacted surfaces together and form a laminate comprising the first and second textiles.

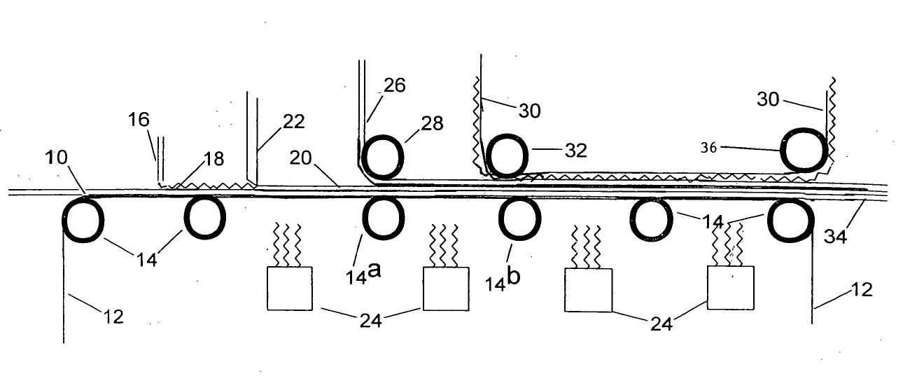

### BACKGROUND OF THE INVENTION

1. Field of the Invention

The invention relates to a novel one-step textile lamination, e.g., carpet construction method.

2. Description of the Prior Art

In the carpet manufacturing industry, one of the most common methods currently being used to coat carpet is a process by which the carpet greige (i.e., yarn tufted into a primary backing) is introduced to the adhesive material in a face down configuration. The adhesive material most commonly used is a styrene-butadiene-rubber (SBR) latex, which is mechanically frothed to a specific consistency with air. The material is then applied to the backstitches thru a delivery hose that traverses the width of the carpet as it travels forward. A blade or a roller is positioned at the lay-down of the latex and forces the material back, and down into the carpet yarn fibers. Simultaneously at another coating station, the secondary, which is usually a woven polypropylene, travels over a roller which applies a second SBR coating directly to it. A blade positioned just past the roller scrapes back the excess amount and levels the application of the adhesive. Usually the formulations of the respective SBR compositions are different because of their intended end uses.

The coated carpet and the coated secondary travel separately toward a curing oven. The coated carpet is now inverted to a face-up configuration as it comes into contact with the coated secondary. Together, while traveling on tenter chains with pins in order to hold the carpet and secondary tight and under tension while pulling them forward into the curing oven, the secondary and carpet are pressed together by a press-roller. Pressed and being held together by the tension of the tenter the composite travels on into the curing oven, usually a series of gas fired penthouses. The tenter chain extends in width in order to apply a constant tension which maintains contact between the secondary and the carpet as the curing process is completed. More particularly, carpets are generally produced by tufting carpet yarns into a primary backing, the tufts being secured in the primary backing through use of a precoat, a foam, or a tuftbind adhesive. This carpet without a precoat of tuftbind adhesive is typically referred to as a greige good. The greige good is optionally coated with adhesive and secured to a secondary backing, generally of polypropylene or jute. Key properties of the carpeting produced by these processes are tuft bind, i.e. the strength required to pull tufts from the primary backing, and delamination strength, i.e., the force required to separate the secondary backing from the carpet.

The manufacture of carpet by implanting tufts in an adhesive composition spread on a backing material is known and described, for example, in British Patent 1,121,036 and U.S. Pat. No. 6,533,863. This requires the adhesive to be applied to a moving web of backing material in such a way as to form a uniform layer. A doctor blade, also commonly referred to as a doctor bar, is typically used to spread the adhesive or coating into a layer on the back of the greige good. In order to accommodate variations in the thickness of the greige good, backing material and/or in the desired adhesive layer, the doctor blade is mounted in an adjustable manner that allows it to be moved towards and away from a structural element (i.e., a bedplate) over which the web of material passes.

Carpets and artificial turfs are typically produced in widths about 12 to about 15 feet, but can be wide as up to about 18 feet. The manufacturing process requires that the doctor blade be about the same length as the width of the carpet, i.e., about 12 to 15 feet and possibly about 18 feet. This is necessary to enable the doctor blade to span the width of the carpet as it passes underneath the blade. The doctor blade is normally built up from one or more machined sections secured to a supporting truss or other suitable supporting means (e.g., an I beam). In order to maintain the edge of the blade accurately across the width of the web of material or greige good, the supporting truss is usually rather large, and considerable strength is required to adjust the mechanism. See U.S. Pat. No. 5,036,793.

Recently, an improved process for precoating a carpet greige backing and adhering it to a secondary backing employing a reactive polyurethane precursor adhesive has been perfected. According to the improved process, the carpet greige is introduced to the coating application in the face down position, backstitch up. A mechanically air-frothed polyurethane precursor precoat at approximately 30 oz./ sq. yd. of material is applied to the backstitch by a traversing hose which travels the width of the carpet as it travels forward. A doctor blade scrapes back and drives the precoat into the fiber. This ensures a more even coating while forcing the adhesive material into the carpet yarn. The precoated carpet immediately goes on to a tenter with pins, which pulls the carpet forward into the curing oven, e.g., a series of gas-fired penthouses. By extending the width of the tenter frame, tension is created on the carpet. The carpet with the cured polyurethane exits out of the oven, is depinned and then proceeds to a second coating station. The carpet with cured precoat is still inverted, backstitch up. A mechanically air-frothed polyurethane laminate coating is then applied over the precoated carpet by a traversing hose which travels the width of the carpet while the carpet is still traveling forward. The difference in the two polyurethane coatings is that the laminate coating has been formulated to froth more easily so it can be gauged on instead of being scraped-on or roller coated.

A specific amount of laminate adhesive is added to the already precoated carpet, approximately 25 oz. sq. yd., in order to fill the precoat voids and to have enough mass to laminate the secondary fabric. The tenter is expanded in the width direction in order to apply tension to the carpet, thereby making it flat and receptive to laying thereon a secondary fabric. The precoated carpet with the coated laminate is now introduced back onto a tenter chain, which pulls it forward toward the curing ovens. Before entering the penthouse for curing, while the carpet is flat from the tension and the polyurethane laminate coat is still uncured, a secondary fabric, woven or non-woven, is introduced onto the precoat/laminate coated carpet. The tenter tension is increased again and pulls the secondary onto the uncured polyurethane laminate coat. The carpet composite, face down, cured precoat, curing laminate and attached secondary proceeds into the curing ovens. At a predetermined point, based on time and temperatures, the carpet composite passes thru a press roller. This serves two purposes; (1) forces excellent contact between the secondary and the laminate and (2) collapses the laminate foam structure which increases the strength of the laminate.

The carpet construction proceeds for approximately two more minutes for final cure and exits the oven and depins from the tenter. The carpet with the polyurethane precoat, laminate and secondary is cured and proceeds to final processing, e.g., shearing, topical application such as anti stains and wrapping of the rolls for shipping.

Numerous variations on the above themes have been suggested for optimizing the lamination of secondary textile materials to carpet greiges. All, however, require multiple applications of precoat, adhesive, adhesive promoters, enhancers or other coatings on either or both of the greige or secondary in order to achieve acceptable tuft and delamination strengths and acceptable performance characteristics for the finished product. See, e.g., U.S. Pat. Nos. 6,299,715; 5,646,195; 5,612,113; 5,604,267; 5,482,908; 5,462,766; 5,158,922; 4,853,280; 4,853,054; 4,696,849; 4,595,445; 4,743,330; 4,632,850; 4,379,730; 4,267,215; 4,156,524; 3,539,384; 3,533,833; 3,511,696; 3,302,610; 2,534,321; 3,940,525; 3,676,280; 3,679,469; 3,745,054.

It is an object of the present invention to provide an improved one-step method for laminating a carpet or other type of textile greige to a secondary fabric or other substrate.

It is a further object of the invention to provide laminates of carpet or other types of textile greiges and secondary fabrics or other substrates.

### SUMMARY OF THE INVENTION

The foregoing and other objects are realized by the present invention, one embodiment of which relates to forming the carpet (or other type) greige/secondary (or other substrate) laminate by applying an adhesive, e.g., a frothed or foamed polyurethane precursor to a surface of the secondary (or other type of substrate), contacting the thus coated surface with a backstitch surface of a carpet (or other type) greige and subjecting the thus formed laminate to curing conditions, e.g., heat and pressure such that the polyurethane precursor is, 1) forced into the yarns of the backstitch surface of the greige and, 2) is cured to a polyurethane that adhesively secures the backstitch surface of the greige to the secondary (or other substrate).

More particularly, an embodiment of the invention concerns a continuous method of adhesively laminating a first textile substrate to a second textile substrate wherein a single laminating adhesive is applied in one step, the method comprising, moving a web of the first textile along a first substantially horizontal path, coating the upper surface of the moving web of first textile with a substantially uniform layer of adhesive capable of bonding a surface of the first textile to a surface of the second textile, moving a web of the second textile along a second substantially horizontal path that is vertically spaced above the coated surface of, substantially parallel to, substantially coextensive with and moving at substantially the same speed as the moving web of first textile, bringing the coated surface of the moving web of first textile into contact with the lower surface of the moving web of second textile under conditions and for a time sufficient to adhere the contacted surfaces together and form a laminate comprising the first and second textiles.

The method of the invention thus enables the lamination of, for example, a carpet greige to a secondary fabric by a one step process wherein a single adhesive material is applied in one operation, the single adhesive material functioning both as the precoat, which locks in the carpet back stitches and encapsulates the yarn fibers, while also laminating the secondary to the carpet construction.

### BRIEF DESCRIPTION OF THE DRAWINGS

The FIGURE schematically depicts an arrangement of apparatus suitable for carrying out the method of the invention.

### DETAILED DESCRIPTION OF THE INVENTION

The various embodiments of the invention may best be understood following a description of the drawing which has been simplified for ease of understanding. Referring to the FIGURE, a web 10 of secondary backing material, preferably supported on a transport belt 12, e.g., woven fiberglass/Teflon is transported over carrier rolls 14 beneath an adhesive dispenser 16 which lays down a layer of adhesive 18 that is smoothed out into a coating of adhesive of uniform thickness 20 by doctor blade 22. The thus coated web is then moved via carrier rollers 14 over at least one heated platen 24 to cure the adhesive to a partially gelled state most receptive to subsequent contact with the carpet greige. A web of carpet greige 26 is contacted with adhesive coating 20 on web 10 at the nip between combining roller 28 and carrier roller 14^{a} such that the back surface of the carpet greige is adjacent to the coated surface of the web 10. The combined webs 10 and 26 may then be passed over one or more additional heated platens 24 to further cure the adhesive. To achieve optimum penetration of the adhesive into the primary backing and tufted yarns thereat of the carpet greige and optimum bonding between the secondary backing and the greige, pressure may be applied to the laminate by feeding a weighted blanket web 30 on to the upper surface of the greige 22 via combining roller 32 at the nip between it and carrier roller 14^{b}. The weighted laminate may be further heated by additional platens 24 to completely cure the adhesive and produce the final laminate 34. Weighted blanket 30 is removed from the laminate via roller 36.

It will be understood by those skilled in the art that the textiles to be laminated according to the method of the invention may comprise any suitable such materials that may be laminated together in a face-to-face configuration for any purpose or application. The method of the invention is particularly applicable to the lamination of carpet greige goods to secondary backing materials, however.

It will further be understood by those skilled in the art that the method of the invention may be carried out employing any suitable adhesive material capable of being coated on the surface of a continuously moving web of textile material. Suitable such adhesives include styrene-butadiene-rubber (SBR) latex, carboxylated SBR latex, natural rubber latex, ethylene/vinyl acetate latex, acrylic latex, polyvinyl chloride plastisols, reactive polyurethane systems, and hot melt compositions, e.g., ethylene/vinyl acetate. It is particularly preferred to employ polyurethane adhesives in the method of the invention, more preferably, frothed or foamed polyurethane precursor adhesives.

The preferred frothed polyurethane precursor foam may be supplied from a frothing apparatus, for example an Oakes or Firestone froth head. The thickness of the adhesives may be gauged by a doctor blade, roller, air blade, etc., all well known to the art. Preferably, the reactive polyurethane components are mixed in a high pressure mixhead prior to being introduced into the frothing head, and fillers, when used, introduced into the polyol side through an in-line mixer rather than being with polyol in a holding tank, all as disclosed in U.S. Pat. No. 5,604,267.

The reactive polyurethane systems comprise one or more di- or polyisocyanates (A-side), and a B-side which comprises one or more polyols, generally polyols having nominal functionalities of from 2 to 8, a low molecular weight chain extender, one or more polyurethane-promoting catalysts, and optionally suitable surfactants, crosslinkers, plasticizers, pigments, and other well known polyurethane additives. In general, a filler is also employed, particularly in froth foam.

The di- and polyisocyanates which are useful include the conventionally used isocyanates such as toluene diisocyanate, including the 2,4- and 2,6-isomers individually or in any admixture, preferably in the common 65/35 and 80/20 mixtures; methylene diphenylene diisocyanates (MDI), in the form of the individual 2,2′-, 2,4′-, and 4,4′-isomers, and mixtures thereof; crude or polymeric MDI having a functionality greater than 2 and comprising mixtures of 2-ring diisocyanates and their higher ring polyfunctional analogs; aliphatic diisocyanates such as 2,4- and 2,6-methylcyclohexane diisocyanate (hydrogenated TDI); 2,2′-, 2,4′-, and 4,4′-dicyclohexylmethane diisocyanates and mixtures of these isomers (hydrogenated MDI); 1,6-hexane diisocyanate, isophorone diisocyanate; and urethane, urea, biuret, uretonimine, uretdione, carbodiimide, isocyanurate, and allophanate modified isocyanates. TDI and MDI or their admixtures are preferred, either as individual isomers or as mixtures.

Isocyanate-terminated prepolymers and quasi-prepolymers are also useful. Isocyanate-terminated prepolymers are prepared by reacting a stoichiometric excess of one or more di- or polyisocyanates with a polyoxyalkylene polyol having a functionality of 2 or higher and an equivalent weight greater than 300 Da (Daltons). Molecular weights and equivalent weights herein are number average molecular and equivalent weights unless indicated otherwise. The isocyanate-terminated prepolymers and quasi-prepolymers advantageously have free isocyanate contents of from about 6% by weight to about 30% by weight. Prepolymers and quasi-prepolymers may be used in conjunction with other isocyanates as a blend.

The polyol component may, in the case where 2-methyl-1,3-propanediol is used as the chain extender, be any suitable polyurethane grade polyol, such as hydroxyl-functional polyester diols, polytetramethylene ether glycols, polycaprolactone diols, and the like, but preferably comprises one or more substantially polyoxypropylene polyols, preferably those which are copolymers with ethylene oxide to provide high primary hydroxyl content. Most preferably, the polyol component comprises, in major part, more preferably in most major part, and most preferably substantially all, of one or more low unsaturation polyoxypropylene polyols having unsaturation levels of less than 0.015 meq/g, preferably less than 0.010 meq/g, and most preferably less than 0.007 meq/g, all as determined by ASTM D 2849-69 “Testing Urethane Foam Polyol Raw Materials.” Polymer polyols, e.g. those containing in situ polymerized vinyl monomers such as styrene and acrylonitrile, and polymer-modified polyols such as PIPA, PID, and PUD polyols may also be used. Preferably, all the polyols of the polyol component are low unsaturation polyols, or are polymer or polymer-modified polyols based on low unsaturation polyols, and most preferably all are ultra-low unsaturation polyols or polymer polyols based thereon, with an average intrinsic unsaturation in the polyol blend of less than 0.010 meq/g, and more preferably less than 0.007 meq/g. Intrinsic unsaturation is defined as the unsaturation which is unavoidably produced during polyoxyalkylene polyol synthesis.

The low and ultra-low unsaturation polyols useful in the present invention may have nominal functionalities between 2 and 8, more preferably between 2 and 6, and most preferably from 2 and 3. The polyols may be homopolymeric polyoxypropylene polyols, but are preferably copolymeric polyoxypropylene/polyoxyethylene polyols. In these copolymeric polyols, oxyethylene moieties may be randomly distributed, or may be in block or block random form. Polyols having terminal oxypropylene/oxyethylene blocks of high oxyethylene content or polyoxyethylene capped polyols are particularly suitable. Most preferably, the polyols are polyoxypropylene copolymer polyols containing random internal oxyethylene moieties with a finish of high oxyethylene content or all oxyethylene moieties. The total oxyethylene content should, in general, be less than 35 weight percent. The low and ultra-low unsaturation polyols may be prepared as taught in U.S. Pat. Nos. 5,470,812, 5,482,908, 5,545,601, 5,158,922, and 5,689,012. Such polyols are available commercially from the ARCO Chemical Company, for example under the trade name ACCLAIM.TM. polyether polyols.

The actual functionalities of low and ultra-low unsaturation polyols are close to the respective nominal functionalities. For ultra-low unsaturation polyols, for example, the actual functionality of a polyoxypropylene diol with a nominal functionality of 2 is ordinarily about 1.95 or greater, whereas the functionality of an analogous triol is ordinarily about 2.80 or greater. The average functionality of the polyol blends of the subject invention should range from 1.9 to about 3, more preferably 1.95 to about 2.6, and most preferably about 1.95 to about 2.4. These average functionalities are based on actual functionalities. The polyol functionalities useful will depend to some degree on the functionality of the isocyanate, with polyol functionalities in the higher portion of the range suitable with isocyanates with functionalities close to 2, and the lower portion of the range most suitable with isocyanates having a higher functionality, for example in the range of 2.2 to 2.4 or higher. The polyols advantageously have equivalent weights of 800 Da to 5000 Da, more preferably 1000 Da to 4000 Da, and most preferably 1000 Da to 2500 Da.

The chain extenders useful in the subject invention are advantageously isocyanate-reactive compounds bearing between 2 and 3 isocyanate-reactive groups per molecule, and an equivalent weight ranging from about 31 Da to about 250 Da. Most preferably, the isocyanate-reactive groups are hydroxyl groups, although other groups well known to those skilled in the polyurethane arts, such as amino groups, may also be used. Preferred chain extenders are low equivalent weight diols such as ethylene glycol, diethylene glycol, triethylene glycol, propylene glycol, dipropylene glycol, tripropylene glycol, 1,3-propanediol, 1,4-butane diol, 1,6-hexanediol, 2,2,4-trimethylpentanediol, glycerine, and trimethylolpropane.

It is known that 2-methyl-1,3-propanediol is a particularly excellent chain extender, yielding increases in tuft bind and/or elongation when used alone or in conjunction with other chain extenders. When used with other chain extenders, 2-methyl-1,3-propanediol preferably constitutes 20% or more by weight of the chain extender component, more preferably 30% or more by weight, and yet more preferably, constitutes a major portion of the chain extender. The chain extender component, when used, may be employed in amounts of greater than 0 to 0.5 parts by weight per part by weight of the polyol component, more preferably 0.05 to 0.4 parts by weight, and more preferably about 0.1 to about 0.3 parts by weight, these parts by weight based on a chain extender equivalent weight of about 50 Da. Higher and lower equivalent weights will generally necessitate larger and smaller proportions of chain extender, respectively.

The compositions are normally catalyzed by urethane promoting catalysts, e.g. those which accelerate the reaction of isocyanate groups with hydroxyl groups. Conventional tin catalysts and amine catalysts are useful, for example, either singly or in admixture. Examples are tin catalysts such as tin octoate, dimethyltin diacetate, diethyltin diacetate, dibutyltin diacetate, dibutyltin dilaurate, among others; and amine catalysts such as diethylene triamine and triethylene diamine. Other catalysts such as the various transition metal acetylacetonates, bismuth compounds, and the like may also be used. Latent catalysts which do not become active until heated are also useful, either alone or in combination with other conventional catalysts.

Fillers, when employed may be selected from those traditionally used, for example finely divided, ground, precipitated or microcrystalline fillers such as aluminum hydroxide, felspar, dolomite, calcium carbonate, limestone, and wollastonite, among others. Mixtures of aluminum hydroxide and calcium carbonate, the latter often in the form of finely ground limestone, are preferred.

When the adhesive is to be used in the form of a foam, either a blown foam or a froth foam or combinations thereof may be used. Froth foams are preferred. Blowing agents in blown and froth/blown foams may be selected from those conventionally used, including fluorochlorocarbons, in particular R-22 (dichlorodifluoromethane), but are more preferably low boiling hydrocarbons, ketones, ethers, carbonates, or the like, and most preferably is water, either alone or in conjunction with another blowing agent. Solid blowing agents may also be useful but are not preferred.

Froth foams are preferably prepared as disclosed in U.S. Pat. No. 5,604,267. Froth foams may also be prepared in the conventional manner by introducing the reactive ingredients together with a substantially inert gas such as air, nitrogen, argon, carbon dioxide, or the like, into a froth mixer such as an Oakes or Firestone mixer. Froth and blown/froth foams are generally gauged with a doctor blade or roller, or the like, to the desired thickness. Frothed foams may also include a volatile or reactive blowing agent in addition to being mechanically frothed.

Pigments may be added when desired to impart color to the polyurethane adhesive. Pigments, which are used in most minor amounts, e.g. less than 2% by weight, should be considered distinct from fillers which are used in far larger amounts and for a different purpose. Plasticizers and other ingredients may be added as desired, as well as crosslinkers such as triethanolamine and diethanolamine.

Moreover, the skilled artisan will be aware that systems of apparatus other than that depicted in the FIGURE may be employed in the practice of the method of the invention without departing from the spirit of the invention.

In a preferred method of the invention the adhesive material such as polyurethane precursor, e.g., is frothed mechanically with air. The frothed weight is specified in grams per liter and is predetermined based on the properties desired in the final product and the natures of the greige and secondary. The adhesive material is then preferably delivered through a hose which traverses the width laying down the blended polyurethane adhesive on a surface of a secondary fabric. The latter may comprise woven or nonwoven fabrics made from one or more of natural or synthetic fibers or yams including jute, wool, polypropylene, polyethylene, polyamide, polyesters, rayon, or various copolymers, such as ethylene/vinyl acetate, as well as needle-punched products.

In a particularly preferred embodiment of the invention, approximately twenty-five ounces per square yard of frothed polyurethane is applied in a typical operation with it being understood that differing amounts may be applied depending upon the carpet greige and secondary constructions. The adhesive material is gauged on one-one hundred thousands of an inch by a blade over a trued roller.

After the application and gauging of the adhesive on to the secondary fabric the latter is carried by a woven fiberglass/Teflon coated transport belt over a series of steamed heated platens. The temperature settings of the platens are set and the speed of the belt are synchronized so as to deliver the polyurethane adhesive/secondary at a state of cure that would be most receptive when contact is made with the greige carpet. The carpet greige preferably has traveled above and parallel to the curing polyurethane/secondary composite prior to the contact point therebetween. The greige carpet/polyurethane composite contact point has been predetermined based on the cure profile of the adhesive so as to maximize the propensity of the polyurethane to penetrate and saturate the yarn fibers.

It is also desirable to apply downward pressure on the carpet to force contact with the polyurethane coated secondary. The weight on the pressure blanket is across the width and length which has been established based on the cure profile. The weight system serves two purposes: (1) to force the adhesive up into the bundles of yarn and (2) to hold the carpet in contact with the adhesive and secondary until the cured polyurethane has sufficient strength to hold the composite together. The length of the pressure blanket can vary from about ten feet to about sixty feet dependent mainly on the natures of the products and/or processing speeds. The heated platens underneath the pressure blanket preferably extend past the length of the run in order to ensure complete, total cure of the polyurethane adhesive. The carpet composite exits off of the curing platens into an accumulator and on to a roll-up for further processing.

The unique aspects of the method of the invention include:
1) A one-step method occasioned by the utilization of one adhesive precoat material in one application.
2) Application of an adhesive precoat onto the secondary fabric instead of the carpet greige as in conventional methods.
3) Maximum utilization of the amount of adhesive material being used and needed.
4) Directed heat from platens through the belting material, through the secondary into the polyurethane adhesive precoat.
5) The use of a tenter is not required which eliminates unwanted tensions being applied when transporting the carpet composite or extensions of width to make it receptive to receipt of a secondary.

### EXAMPLE

The carpet selected for the run was a tufted synthetic turf product most commonly coated with unitary polyurethane with no secondary. One of the reasons for selection of this type product was that a history of processing and physical properties was available. The polyurethane formulation for the precoat/laminate was formulated as follows:

| CHEMICALS | PARTS |
|---|---|
| Polyol | 100 |
| Calcium Carbonate | 235 |
| Catalyst | .018 |
| Secondary Catalyst | 1.26 |
| Isocyanate | 55.3 |
| Polyol | 2.59 |
| Surfactant | .5 |

Utilizing a system as depicted in the FIGURE, the formulation was mixed with air through a blender to a cup weight of 500 grams per liter. The foam mixture then travels though a hose which traverses a width of one hundred ninety inches. The polyurethane adhesive was applied on top of a 3.5 ounce per square yard non-woven polyester secondary. The application weight is twenty-five ounces per square yard. The frothed polyurethane adhesive is then gauged on at one-one hundred thousands of an inch by preset blade over a trued roller as it travels forward.

The travel of the coated secondary is 25-ft./min. on a belted carrier over 250 degrees F. steamed heated platens for approximately sixty feet before contact of the curing polyurethane with a run of uncoated synthetic turf. The polyurethane adhesive is still ungelled and wet to the touch at the point of contact with the carpet. The carpet marries into the uncured adhesive and travels approximately five feet in contact before pressure by a weighted blanket forces intimate contact between the carpet and the coated secondary. Pressure is then applied for approximately thirty feet while still traveling over heated platens. The precoat-laminate adhesive is crushed by pressure while held in intimate contact with the polyurethane adhesive as it cures to a point that holds the composite together. The semi-cured composite travels, another one hundred feet over heated platens to finish the cure.

The finished synthetic turf, which has been precoated and laminated to a secondary, exits the belted line and goes to a roll-up for wrapping.

From the foregoing description, various modifications and changes in the composition and method will occur to those skilled in the art. All such modifications coming within the scope of the appended claims are intended to be included therein. The entire disclosures and contents of each and all references cited and discussed herein are expressly incorporated herein by reference. All percentages expressed herein are by weight unless otherwise indicated.

1. A continuous method of adhesively laminating a first textile substrate to a second textile substrate wherein a single laminating adhesive is applied in one step, said method comprising,
moving a web of said first textile along a first substantially horizontal path,
coating the upper surface of said moving web of first textile with a substantially uniform layer of adhesive capable of bonding a surface of said first textile to a surface of said second textile,
moving a web of said second textile along a second substantially horizontal path that is vertically spaced above said coated surface of, substantially parallel to, substantially coextensive with and moving at substantially the same speed as said moving web of first textile,
bringing the coated surface of said moving web of first textile into contact with the lower surface of said moving web of second textile under conditions and for a time sufficient to adhere said contacted surfaces together and form a laminate comprising said first and second textiles.

2. The method of claim 1 wherein said first textile is a secondary carpet backing and said second textile is a carpet greige.

3. The method of claim 2 wherein said secondary carpet backing is a non-woven textile.

4. The method of claim 3 wherein said non-woven textile comprises polyester.

5. The method of claim 2 wherein said secondary carpet backing is a woven textile.

6. The method of claim 2 wherein said carpet greige is an artificial turf.

7. The method of claim 1 wherein said adhesive is frothed.

8. The method of claim 7 wherein said frothed adhesive is a styrene-butadiene-rubber latex or a polyurethane precursor.

9. The method of claim 1 wherein said adhesive is heat activatable.

10. The method of claim 9 wherein said conditions sufficient to adhere said contacted surfaces include elevated temperatures sufficient to activate said adhesive.

11. The method of claim 10 wherein said elevated temperatures are provided by at least one heat source positioned below the lower surface of said moving web of first textile.

12. The method of claim 1 wherein said conditions sufficient to adhere said contacted surfaces include increased pressure on said surfaces to enhance contact therebetween.

13. The method of claim 12 wherein said elevated pressure is applied to the upper surface of said moving web of second textile.

14. The method of claim 13 wherein said elevated pressure is applied to said upper surface of said moving web of second textile by moving a weighted third web along a third substantially horizontal path that is above said upper surface of, substantially parallel to, substantially coextensive with and moving at substantially the same speed as said moving web of second textile, and bringing the lower surface of said moving weighted third web into contact with said upper surface of said second textile.

15. The laminate produced by the method of claim 1.

16. A continuous method of adhesively laminating a secondary backing to a carpet greige wherein a single laminating adhesive is applied in one step, said method comprising,
moving a web of said secondary backing along a first substantially horizontal path,
coating the upper surface of said moving web of secondary backing with a substantially uniform layer of adhesive capable of bonding a surface of said secondary backing to a surface of said carpet greige,
moving a web of said carpet greige along a second substantially horizontal path that is vertically spaced above said coated surface of, substantially parallel to, substantially coextensive with and moving at substantially the same speed as said moving web of secondary backing,
bringing the coated surface of said moving web of secondary backing into contact with the lower surface of said moving web of carpet greige under conditions and for a time sufficient to adhere said contacted surfaces together and form a laminate comprising said secondary backing and carpet greige.

17. The method of claim 16 wherein said secondary carpet backing is a non-woven textile.

18. The method of claim 17 wherein said non-woven textile comprises polyester.

19. The method of claim 16 wherein said secondary carpet backing is a woven textile.

20. The method of claim 16 wherein said carpet greige is an artificial turf.

21. The method of claim 16 wherein said adhesive is frothed.

22. The method of claim 21 wherein said frothed adhesive is a styrene-butadiene-rubber latex or a polyurethane precursor.

23. The method of claim 16 wherein said adhesive is heat activatable.

24. The method of claim 23 wherein said conditions sufficient to adhere said contacted surfaces include elevated temperatures sufficient to activate said adhesive.

25. The method of claim 24 wherein said elevated temperatures are provided by at least one heat source positioned below the lower surface of said moving web of first textile.

26. The method of claim 16 wherein said conditions sufficient to adhere said contacted surfaces include increased pressure on said surfaces to enhance contact therebetween.

27. The method of claim 26 wherein said elevated pressure is applied to the upper surface of said moving web of second textile.

28. The method of claim 27 wherein said elevated pressure is applied to said upper surface of said moving web of second textile by moving a weighted third web along a third substantially horizontal path that is above said upper surface of, substantially parallel to, substantially coextensive with and moving at substantially the same speed as said moving web of second textile, and bringing the lower surface of said moving weighted third web into contact with said upper surface of said second textile.

29. The laminate produced by the method of claim 16.
